(19) United States
(12) Patent Application Publication
(10) Pub. No.: US 2010/0168903 A1
(43) Pub. Date: Jul. 1, 2010

(54) CASH TRANSPORT APPARATUS

(76) Inventors: Per Christian Aas, Oslo (NO); John-Haakon Lippert, Klokkarstua (NO); Anders Ekberg, Loddekopinge (SE)

Correspondence Address: WOMBLE CARLYLE SANDRIDGE & RICE, PLLC, ATTN: PATENT DOCKETING, P.O. BOX 7037, ATLANTA, GA, 30357-0037, US

(21) Appl. No.: 12/695,362

(22) Filed: Jan. 28, 2010

Related U.S. Application Data
(63) Continuation of application No. PCT/SE2008/000462, filed on Jul. 24, 2008.
(60) Provisional application No. 60/955,090, filed on Aug. 10, 2007.

(30) Foreign Application Priority Data
Aug. 10, 2007 (SE) 0701845-0

(51) Int. Cl. G06F 7/00; B65D 83/08; G06F 17/10; G06F 17/00; G06F 3/048; H04K 1/00

(52) U.S. Cl. 700/214; 221/45; 701/300; 700/231; 715/772; 380/255

(57) ABSTRACT

A cash transport apparatus is configured to be externally connected to a note handling apparatus only during a procedure of distribution of notes between said note handling apparatus and said transport apparatus. The transport apparatus comprises a first opening configured to interface with a second opening in said note handling apparatus thereby enabling the distribution of notes between said note handling apparatus and said transport apparatus, a note storage component comprising at least one drum able to rotate in both directions and configured to store notes by at least one layer of film spooled onto said at least one drum, and a power input connector configured to receive electric power from said note handling apparatus and provide the electric power to said note storage component.

### CROSS-REFERENCE TO RELATED APPLICATIONS

This application is a continuation application of prior PCT application No. PCT/SE2008/000462, filed Jul. 24, 2008 and designating the United States, entitled “Cash Transport Apparatus” which PCT application claims the benefit of U.S. Provisional Application No. 60/955,090, filed on Aug. 10, 2007, and Swedish Patent Application No. 0701845-0, filed Aug. 10, 2007.

### INCORPORATION BY REFERENCE

The entire disclosures of PCT Application No. PCT/SE2008/000462, filed Jul. 24, 2008; U.S. Provisional Application No. 60/955,090, filed Aug. 10, 2007; and Swedish Patent Application No. 0701845-0, filed Aug. 10, 2007, are incorporated herein by reference as if set forth in their entireties.

### TECHNICAL FIELD

The present application relates to handling of cash in a cash handling system comprising a plurality of interacting entities, and specifically to arrangements for transporting cash between cash handling system entities.

### BACKGROUND

Cash, not least in the form of bank notes, will continue to fulfil a large and vital role or function in payment systems all around the world for a long time to come. Although electronic payment systems in which cash in the form of bank notes have been eliminated are becoming more and more widespread, there is still a large need to cater for transactions that are simple and have no need for complex electronic equipment.

The simplicity of using cash for performing transactions is, however, closely and inevitably coupled to problems of how to prevent unauthorized access to the cash. Such problems are relevant with respect to all stages involved when preparing for and making any transaction involving cash. For example, when preparing for and when performing transport of cash from a shop, retail location or automatic teller machine (ATM) to a cash depository, such as a cash centre, or financial institute, such as a bank, there are typically a large number of procedures and protection systems involved in order to prevent unauthorized access to the cash. Hence, one specific area of interest is that of providing a secure and easy to use cash transport unit.

Examples of prior art cash transport arrangements typically include more or less tamper-proof portable cases capable of holding stacks of notes that have been removed by hand from, e.g., an ATM and put into the transport case by hand. A drawback of such arrangements is that they typically require additional safety measures in order to protect from unauthorized access to the cash that is to be transported in the case.

### SUMMARY OF THE INVENTION

An object of the present invention is to overcome drawbacks related to cash handling disclosed in the prior art.

Hence, the present invention provides a cash transport apparatus configured to be externally connected to a note handling apparatus only during a procedure of distribution of notes between said note handling apparatus and said transport apparatus. The transport apparatus comprises a first opening configured to interface with a second opening in said note handling apparatus thereby enabling the distribution of notes between said note handling apparatus and said transport apparatus, a note storage component comprising at least one drum able to rotate in both directions and configured to store notes by at least one layer of film spooled onto said at least one drum, and a power input connector configured to receive electric power from said note handling apparatus and provide the electric power to said note storage component.

The cash transport apparatus may be configured such that the interfacing prevents external access to notes being distributed between the transport unit and the cash handling apparatus. Moreover, distribution of notes may include any of input of notes, output of notes, input and output of notes.

Such a transport unit provides a safe system of conveying cash between different cash handling entities. In fact, one single transport unit may advantageously be used to connect with any number of cash handling entities. That is, a user may use one transport unit while travelling from one cash handling entity to another, performing conveying of cash with different cash handling entities at every stop. In fact, it is not necessary that it is possible to open up the transport unit during normal use and it may be possible that it could be weeks, months or even years between operations such as servicing that need access to the inside of the transport unit.

Furthermore, cash is not exposed to any operator during transfer of notes between the transport unit and the note handling apparatus. By the fact that the transport unit is a separate entity, externally connected to a cash handling apparatus only during distribution of notes, unauthorized access is prevented and normal operation of the cash handling apparatus is prevented during note distribution. Moreover, such a configuration makes it possible to configure a cash handling apparatus to allow transfer of large numbers of notes only while a transport unit is attached. This is further accentuated by the fact that the transport unit is configured with a single opening for both output and input of notes. Furthermore, by being powered from the note handling apparatus, additional protection against tampering may be obtained.

The cash transport apparatus may comprise a connection locking mechanism configured to lock the connection between the transport apparatus and the note handling apparatus during the procedure of distribution of notes between said note handling apparatus and said transport apparatus.

The note storage drum may be configured with a drum locking mechanism configured to prevent and allow rotation of the drum. This drum locking mechanism may be configured to detect that the transport apparatus is connected to the note handling apparatus and configured to prevent and allow rotation of the drum in response to said detection.

The note storage component may be configured such that notes can be stored on said at least one drum by being rolled between two layers of film, spooled onto said at least one drum.

The cash transport apparatus may also comprise at least one note guiding roller arranged adjacent said first opening and configured to rotate in both directions for facilitating receiving and dispensing of notes to and from said storage component. Embodiments include where the roller has an outer peripheral surface interacting with notes, the interaction resulting in alteration of the direction of motion of notes into any of at least a first alternative direction and a second alternative direction. This note guiding roller may be a foam roller.

The cash transport apparatus may also comprise at least one note guiding means arranged adjacent said first opening and configured in the form of an inclined ramp, the inclination of which is such that it directs notes towards the roller.

Furthermore, the cash transport apparatus may also comprise a signal connector configured to convey signals between the transport apparatus and the note handling apparatus, and the note storage component may be responsive to control signals among said signals such that the procedure of distribution of notes between said note handling apparatus and the transport apparatus is controlled.

The cash transport apparatus may also comprise control circuitry and the note storage component may be responsive to control signals from said control circuitry such that the procedure of distribution of notes between said note handling apparatus and the transport apparatus is controlled.

Such control circuitry may comprise timing circuitry configured such that said note storage component is responsive to said control signals from said control circuitry in such a way that the procedure distribution of notes between said note handling apparatus and said transport apparatus is enabled only during at least one specific time interval.

The cash transport apparatus may further comprise a user interface unit that is responsive to any of said signals such that it is capable of at least provide an indication of the progress of the procedure of distribution of notes between said note handling apparatus and the transport apparatus.

The cash transport apparatus may further comprise encryption and decryption circuitry that is configured to encrypt and decrypt any of said signals.

The cash transport apparatus may further comprise geographic location determination circuitry and where said note storage component is responsive to control signals from said geographic location determination circuitry such that the procedure of distribution of notes between said note handling apparatus and the transport apparatus is controlled in dependence on a determined geographic location of the transport apparatus.

The cash transport apparatus may further comprise an ink dye protection system that includes at least one sensor for sensing any of a change of temperature, mechanical chock, intrusion, a time delay and a specific time, at least one dye container, and control circuitry configured to detect sensor output and controlling emission of dye from the dye container onto the note storage component. The dye container may be attached to the note storage drum or be an integral part of the note storage drum. Furthermore, at least one dye ejector may be connected to the dye container, where the dye ejector is attached to the note storage drum. The dye ejector may be in the form of a nozzle, slit or any appropriate opening configured to convey dye from the dye container onto the note storage component.

### BRIEF DESCRIPTION OF THE DRAWINGS

FIG. 1 schematically illustrates a cash handling system in which a transport unit is operated.

FIG. 2 schematically illustrates a block diagram of cash transport unit.

FIG. 3 schematically illustrates a block diagram of cash handling apparatus.

FIG. 4a schematically illustrates a side view of a cash transport unit.

FIG. 4b schematically illustrates a perspective view of a part of the cash transport unit of FIG. 4a.

FIGS. 4c and 4d schematically illustrates a perspective view of a cash transport unit and a cash processing unit, respectively.

FIG. 4e schematically illustrates a perspective view of an inclined ramp, being a detail of the cash transport unit of FIGS. 4a-c.

FIG. 4f schematically illustrates a side view of interaction between an inclined ramp and a note guiding roller, being a detail of the cash transport unit of FIGS. 4a-c.

### DETAILED DESCRIPTION OF EMBODIMENTS

It is to be noted that throughout this description, the expressions “cash” and “note” are used to describe any type of item having a structure that is similar to a banknote, i.e. flexible sheet-like items having essentially a two-dimensional spatial extent.

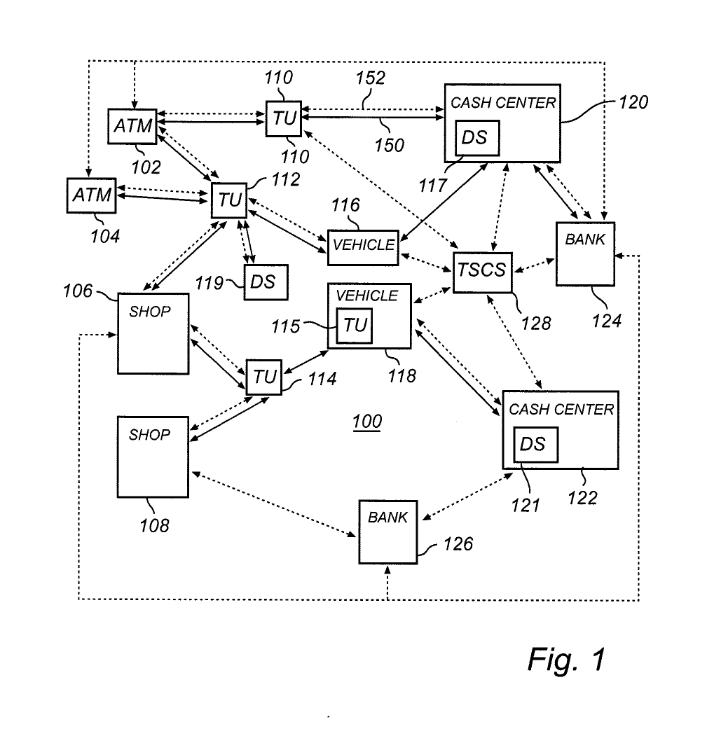

Turning now to FIG. 1, a cash handling system 100, in which transport units according to the present invention may be used, will now be described in general terms. In FIG. 1, solid line arrows, as exemplified by an arrow having reference numeral 150, represent exchange of cash between entities in the system 100. Dashed line arrows, as exemplified by an arrow having reference numeral 152, represent exchange of information signals between entities in the system 100. The arrows have dual arrow heads, pointing in opposing directions, in order to illustrate that the flow of cash as well as the flow of information signals is in any direction between the entities of the system 100. The flow of information between the different entities may, as the skilled person will realize, be implemented using any appropriate data communication protocol and protection and security may be provided by the use of any authentication, authorization and accounting protocol (AAA-protocol) known in the art. The physical flow of information may entail galvanic connection between communicating entities as well as utilization of wireless connections, as will be exemplified and discussed in more detail below.

The system 100 comprises a plurality of automatic teller machines (ATM) of which a first ATM 102 and a second ATM 104 are illustrated. The ATMs 102, 104 are configured to automatically provide and receive cash during interactions with a human customer.

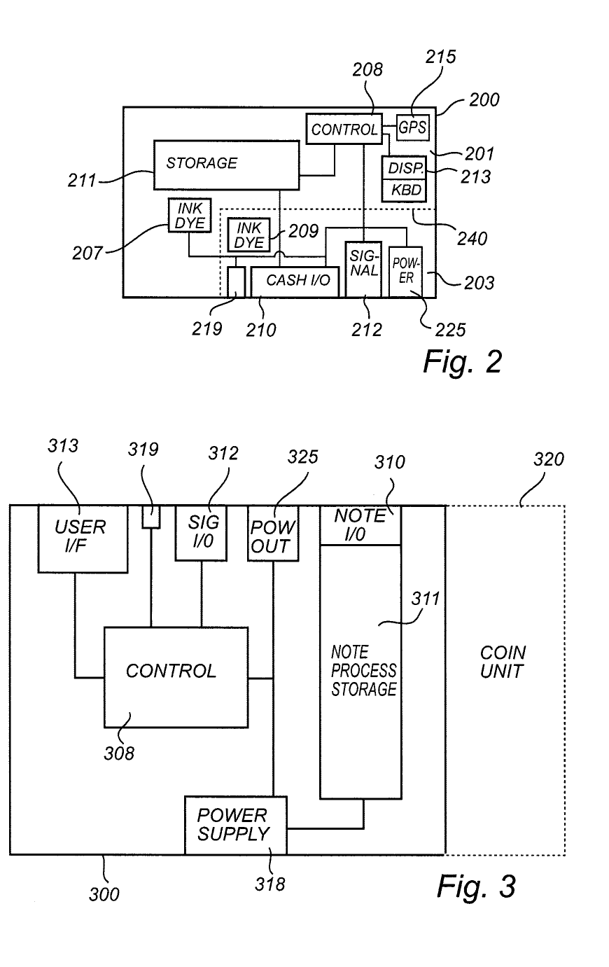

Further, the system 100 comprises a first retail shop 106 and a second retail shop 108. As the skilled person will realize, the shops 106, 108 may represent any form of shop-like cash handling entity where human interaction takes place between a customer and a teller who operates a cash handling apparatus (e.g. a cash handling apparatuses 302 as described below in connection with FIGS. 2 and 3) located in the shop 106, 108. As the skilled person will realize, the teller typically performs transactions in which cash is provided into and withdrawn from the cash handling apparatus. Alternatively, a customer may perform cash transactions in a self-service manner without assistance from a teller.

A number of cash transport units 110, 112 and 114 form parts of the system 100. The transport units are configured, as will be described in more detail below, to store cash in a secure manner and configured to receive cash input and dispense cash during interactions with other entities in the system 100. As indicated by solid line arrows, cash is moved between transport unit 110 and ATM 102, between transport unit 112 and ATMs 102, 104 and shop 106 and between transport unit 114 and shops 106 and 108. Similarly, as indicated by dashed line arrows, information signals are transmitted between transport unit 110 and ATM 102, between transport unit 112 and ATMs 102, 104 and shop 106 and between transport unit 114 and shops 106 and 108. An important property of the transport units is that they each form an individual part of the system 100 and, when properly configured, any transport unit may interact with any other entity in the system. Typically, the transport units 110, 112, 114 are portable boxes having appropriate physical dimensions and weights and mechanical arrangements for enabling simple movement, e.g. handles, such that one person will be capable of moving a transport unit.

Bulk transport of cash in the system 100 is provided by way of vehicles 116 and 118. As indicated by solid line arrows, cash is moved between transport unit 112 and vehicle 116 and cash is moved between transport unit 114 and vehicle 118. It is to be noted that the transport of cash, as indicated by the solid lines discussed above, may entail transporting a cash transport unit within a vehicle 116, 118, as illustrated by a cash transport unit 115 located within vehicle 118. However, the transport may involve any other type of cash container known in the art, e.g. cash bags and cash boxes, into which cash has been provided from the transport units. For example, as will be discussed further below, a transport unit may dock with a docking station 117 that provides cash into bags.

Signalling, i.e. transmission of information signals, is also performed between the vehicle 116 and the transport unit 112. However, as exemplified by vehicle 118 and transport unit 114, signalling may be omitted although cash is moved.

A transport service control centre 128 is shown being configured for exchange of information signals with the vehicles 116, 118, cash centres 120, 122 and a bank 124. Signalling between the transport service control centre 128 and individual transport units is also possible, as indicated by the signalling connection with transport unit 110. The transport service control centre 128 is typically an entity representing a provider of transport services, including vehicles and vehicle staff, to other entities in the system such as shops, banks, ATM operators etc. No cash is being conveyed via the transport service control centre 128. The information signals that are exchanged with other entities of the system include such information as instructions regarding collection of cash from a shop or an ATM, status information such as geographical location and any security status information and supervisory information needed in order to provide a secure transport service.

The system further comprises a number of cash centres 120 and 122. The cash centres 120, 122 perform the function of being depositories for cash and receive and provide cash to vehicles 116 and 118, respectively. Moreover, as illustrated by the solid arrow 150 between cash centre 120 and transport unit 110, cash may be provided directly from a transport unit, i.e. transport unit 110, to a cash centre and vice versa without the utilization of a vehicle. Cash centres may be located at specific cash centre locations, typically in the form of a specifically configured, relatively large, building complex located remote from other buildings and into which vehicles carrying cash are moved. However, a physically relatively small cash centre may also be located in close vicinity to one or more shops, such as in a shopping mall.

A first cash docking station 117 is illustrated within the cash centre 120. Operation of the cash docking station 117 typically involves at least one transport unit out of which, or into which, cash is provided. For example, a docking station is configured to mate with a cash transport unit and to cooperate such that cash is conveyed from the transport unit into the docking station, where the cash may be processed, and out of the docking station. The output of cash from the docking station may be as simple as feeding cash onto a table surface but also more elaborate such as feeding cash into a cash container. Such a cash container, although not illustrated in FIG. 1, may be a cash bag, another cash transport unit, a typical ATM cash cassette or any other suitable container configured to mate with the docking station.

Although the docking station 117 in FIG. 1 is illustrated to be located within the cash centre 120, other locations for docking stations are also possible. For example, as will be discussed in further detail below, a docking station may be located within, or in the vicinity of, a shop and also in a vehicle or a bank etc. as illustrated by a second docking station 119.

Two financial institutes in the form of banks 122 and 124 are also comprised in the system 100. As indicated by the solid line arrow between bank 124 and cash centre 120, cash may be transported to and from the bank. However, as exemplified by bank 126, it is not necessary that the bank 126 receives or provides cash within the framework of the system 100 as discussed here. As illustrated by dashed arrows, information signals are transmitted between the banks 124, 126, the cash centres 120, 122 as well as between the banks 124, 126 and the ATMs 102, 104 and the shops 106, 108.

As the skilled person will realize, the transport of cash between the different entities in the system 100 typically pertain to issues regarding ownership and changes of ownership of the cash that is transported in the system 100

Turning now to FIGS. 2 and 3, a transport unit 200 for transporting cash in the form of notes will be schematically described that is configured to interact with a cash handling apparatus 300 as well as any of the cash handling apparatuses and a docking stations described above with reference to FIG. 1.

The note transport unit 200 illustrated in FIG. 2 comprises a note input/output unit 210 that is configured such that it is capable of being mechanically connected with the cash handling apparatus 300, and thereby configured to convey cash to and from the transport unit 200. The cash input/output unit 210 is configured such that it conveys cash to a cash storage unit 211 connected to the cash input/output unit 210. Mechanical engagement and disengagement, including locking and unlocking, between the input/output unit 210 and other entities is controlled, via an engager 219. The engager 219 may be of an electromechanical type that is controlled by an electronic control signal from, e.g. a control unit in the transport unit 200 itself or a control unit of any entity with which the transport unit is communicating. The cash storage unit 211 is arranged within the transport unit 200 such that it is secure from tampering and thereby stops unauthorized access to stored cash.

A control and communication unit 208 is connected to and configured to control the cash input/output unit 210 during mechanical engaging and disengaging, by means of the engager 219, with the cash handling apparatus 300 and during conveying of cash. The control and communication unit 208 is also connected to, and configured to control, a signalling interface unit 212. The control and communication unit 208 may comprise any suitable programmable circuitry and memory, as the skilled person will realize when implementing the transport unit 200. The control and communication unit 208 is hence provided with one or more computer programs comprising software instructions that, when executed, provide signals to the various functional units within the transport unit 200 as well as communication signals with other entities in a cash handling system.

The signalling interface unit 212 is configured to be connected with a corresponding signalling interface unit 312 in the cash handling apparatus 300, and thereby configured to convey signalling information and data. Signalling may entail exchanging information relating to cash transactions such as time stamps, amounts of cash input or cash output etc. as well as information relating to cash transport procedures during interaction with a cash handling apparatus and docking station such as time stamps, identification and authorization information etc. as well as cash amounts.

Signalling between the transport unit 200 and other entities may also entail exchanging information relating to geographical information, security status of the transport unit etc. For example, by incorporating a positioning unit 215 such as a Global Positioning System, GPS, receiver in the transport unit 200 and connected to the control and communication unit 208 and possibly also to the signalling interface unit 212, information regarding the exact geographical position of the transport unit 200 may be communicated to other entities with which the transport unit 200 communicates. Simpler geographical tracking may be obtained by configuring a Radio Frequency Identification (RFID) tag into the transport unit 200 and incorporating the transport unit 200 in a RFID system.

The transport unit 200 is divided into a secure part 201 and a non-secure part 203 as indicated by a dashed line 240. The secure part 201 is configured such that unauthorized access to the storage unit 211 is prevented. Furthermore, the transport unit 200 also comprises a user interface unit 213 in the form of a display and keypad, for example in the form of a touch sensitive display unit where information regarding the transport unit 200 is displayed and via which an operator, i.e. a person carrying the transport unit 200, may enter information for processing in the control and communication unit 208. Displayed information may include a destination address and other status and operational information.

Ink dye protection is provided by way of a first ink dye system 207 configured within the secure part 201 of the transport unit 200 and a second ink dye system 209 configured within the non-secure part 201 of the transport unit 200. Both ink dye systems 207 and 209 are connected to the control and communication unit 208 and comprise sensors for sensing unauthorized access to any of the secure and non-secure parts of the transport unit 200, for communicating signals to the control and communication unit 208 and for activating ink dyeing of cash. Alternatively, any of the ink dye systems 207, 209 may operate independently without connection to the control and communication unit 208.

The transport unit 200 is also configured with a power input connector 225 that, when the transport unit 200 is attached to another entity, receives electric power from the attached entity. For example, when the transport unit 200 is attached to the cash handling apparatus 300 of FIG. 3, power is received from a power output connector 325 of the cash handling apparatus 300. The transport unit 200 may be configured such that it is more or less inoperable, e.g. incapable of conveying cash, when it is not attached to any power providing entity.

In addition to being used for transport of notes, the transport unit 200 may be configured such that it operates as a cash deposit apparatus, e.g. located at a teller in a shop. Such a configuration may simply entail mechanical mounting arrangements that allow easy access for a teller when feeding notes into the transport unit, while at the same time allowing for removal when ready to be moved by, e.g., a cash transport service. Preferably, a transport unit configured as a deposit apparatus is configured with a user interface that facilitate the use of the transport apparatus when notes are deposited (typically performed manually by a teller). Moreover, such a transport apparatus configuration may comprise a note validator, i.e. arrangements in the input/output unit capable of validate whether or not a note is acceptable or potentially counterfeit. Such a cash deposit apparatus may or may not be connected to a shop control and communication system. Although a transport unit configured as a deposit apparatus is mainly intended for deposit operations, it may also be configured to provide output of notes.

Moreover, the transport unit 200 may be configured with access control configured such that it is necessary for an operator, i.e. a person who is to operate it to connect to an entity in the cash handling system, to authorize by using an access controller to activate circuitry in the transport unit. Such access controller may be of any suitable type, including biometric sensors and more simple password/PIN access controllers.

Furthermore, although the transport unit 200 described above is typically configured to operate in connection with other types of entities in a cash handling system, it is also feasible that two transport units interact directly with each other (including transport units of any other type than those described herein), exchanging information as well as cash, with or without any interface.

The cash handling apparatus 300 illustrated in FIG. 3 may be any of the cash handling apparatuses 106,108, ATM's 102, 104 as well as the docking stations 117,119,121 illustrated in FIG. 1. As already mentioned above, the cash handling apparatus 300 comprises a cash input/output unit 310 that is configured to receive and dispense cash in the form of bank notes. The cash input/output unit 310 is also configured such that it is capable of being mechanically connected with a cash transport unit, e.g. the transport unit 200 of FIG. 2, and thereby configured to convey cash to and from the transport unit. Mechanical engagement and disengagement between the input/output unit 310 and a transport unit is controlled, via electromechanical engagers 319 by a control and communication unit 308 that cooperates with a corresponding controller in the transport unit. As already described, engagement between the cash handling apparatus 300 and the transport unit 200 takes place via the engager 219 in the transport unit 200 and the engager 319 in the cash handling apparatus 300.

Connected to the cash input/output unit 310 and also operated under the control of the control and communication unit 308 is a note processing and storage unit 311. The processing/storage unit 311 is configured to store notes in one or more storage units, for example note storage drums. The control and communication unit 308 may also be configured to control the processing/storage unit 311 to retain any type of notes that are not suitable for circulation, such as potentially counterfeit notes.

The note input/output unit 310 and the storage unit 311 are further configured such that they are capable of being controlled by the control and communication unit 308 to operate in a cash recycling manner. That is, notes that have been input to the storage unit 311 during a first user transaction involving a deposit may be re-used in a later transaction involving any other user to whom notes are dispensed from the storage unit 311.

The control and communication unit 308 is further connected to, and configured to control, a user interface unit 313 that may comprise a display, a keypad and a card reader, the hardware of which will not be discussed in detail as this would clutter the description with details already known in the art.

The control and communication unit 308 may comprise any suitable programmable circuitry and memory, as the skilled person will realize when implementing the cash handling apparatus 300. The control and communication unit 308 is hence provided with one or more computer programs comprising software instructions that, when executed, provide signals to the various functional units within the cash handling apparatus 300 as well as communication signals with other entities in a cash handling system.

As already indicated above, the signalling interface unit 312 is configured to be connected with the corresponding signalling interface unit in the cash transport unit 200, and thereby configured to convey signalling information and data to and from the transport unit. Signalling between an cash handling apparatus and a transport unit may entail exchanging information relating to cash transactions such as time stamps, amounts of cash input or cash output etc. as well as information relating to cash transport procedures during interaction with a cash transport unit such as time stamps, identification and authorization information etc. as well as cash amounts.

The cash handling apparatus 300 is also configured with a power supply unit 318 that provides electric power to the different functional units within the cash handling apparatus 300. The power supply unit 325 is also connected to a power output unit 325, which is arranged in a manner that allows it to provide electric power to a transport unit, e.g. the transport unit 200 described above, when attached to the cash handling apparatus 300.

As indicated in FIG. 3, the cash handling apparatus 300 may also be equipped with a coin handling unit 320. However, a detailed description of such a unit is outside scope of the present specification.

As briefly discussed above, a cash transport unit, such as the unit 200 described above, and each cash handling entity of the system are preferably provided with complementary mechanical formations that co-operate with one another to retain the cash transport unit and a cash handling entity in pre-determined relative positions during flow of cash there between.

Such mechanical formations preferably comprise a releasable locking mechanism acting between the cash transport unit and a cash handling entity for retaining the cash transport unit fast with the cash handling entity until a decision has been made to release the transport unit from the cash handling entity.

The reasons for locking together the transport unit and the cash handling entity may be:

a) security against interference with the transport unit or theft thereof, and

b) safety, to prevent the transport unit tilting or falling with the danger of injury to an operative or member of the public.

The releasable locking mechanism is preferably electro-mechanically actuated.

When the cash handling entity is an ATM, and the cash transport unit is to be hand-carried, the complementary mechanical formations are preferably configured to support the weight of the cash transport unit when the unit is connected to the ATM.

Preferably the complementary mechanical formations then comprise at least one upwardly directed lug on the face of the ATM and at least one downwardly directed hook on the opposing face of the transport unit so arranged as to permit the transport unit to be offered to the ATM and hooked onto the ATM, to assist in supporting the weight of the transport unit.

Preferably the upwardly directed lug is constituted by an upwardly directed flange that extends adjacent to the upper margin of the ATM front face, and the hook is constituted by a downwardly directed flange depending from the housing of the transport unit.

This provides a concealed connection between the two units.

The releasable locking mechanism preferably comprises one or more spring-loaded detents, which preferably project from the housing of the transport unit and co-operate with respective detent recesses provided in the lower part of the front face of the ATM.

The spring-loaded detents preferably each comprise a rounded detent head which may be in the form of a part-spherical head. This can provide a camming/snap-fit on pressing of the transport unit towards the ATM, after engagement of the hooks.

The ATM and transport unit are preferably provided with complementary downwardly-divergent guide formations so configured as to guide the transport unit towards said predetermined assembled position when the hooks are engaged over said ATM lugs and the transport unit is urged/moves downwards to fully engage the hooks and lugs.

Thus the guide formations guide the transport unit in the lateral direction as viewed facing the ATM, as the transport unit moves downwards on the ATM.

The guide formations on the ATM are conveniently provided by protruding portions of the vertical side frame members of the ATM.

An electro-magnetically operated detent locking arrangement is preferably provided to lock the detent in the projected, locking position, the detent locking arrangement comprising, for example, a solenoid-operated pin extending through a bore in the detent when the detent is in a fully-projected position.

Each detent locking arrangement may be used to provide a respective electrical connection between a respective circuit element of the ATM and a respective circuit element of the transport unit.

Each detent recess may be provided in a respective pad that is insulated from the surrounding material in which the pad is seated.

Since the detent recesses need not be very deep, they are easily cleanable in use, and should not attract attention by vandals.

Preferably the circuit elements associated with the detent form part of a signalling circuit for providing signalling between the ATM and the transport assembly.

When the transport unit is required to receive power from the ATM, power connections between the ATM and the transport unit preferably comprise spring-loaded connector pins that engage with respective connector pads, the connector pins preferably being carried by the transport unit, and the connector pads by the ATM housing. (These may be of similar construction to those used on a car's fifth door/hatch-back.)

In other words, mechanical engagement between a transport unit and another entity in the cash handling system may be established in an active manner, by controlling engagers, or in a more passive manner as described above.

Although an ATM has been used above to exemplify mechanical engagement, any other entity in a cash handling system may be configured with equal or similar arrangements for providing equal or similar functionality.

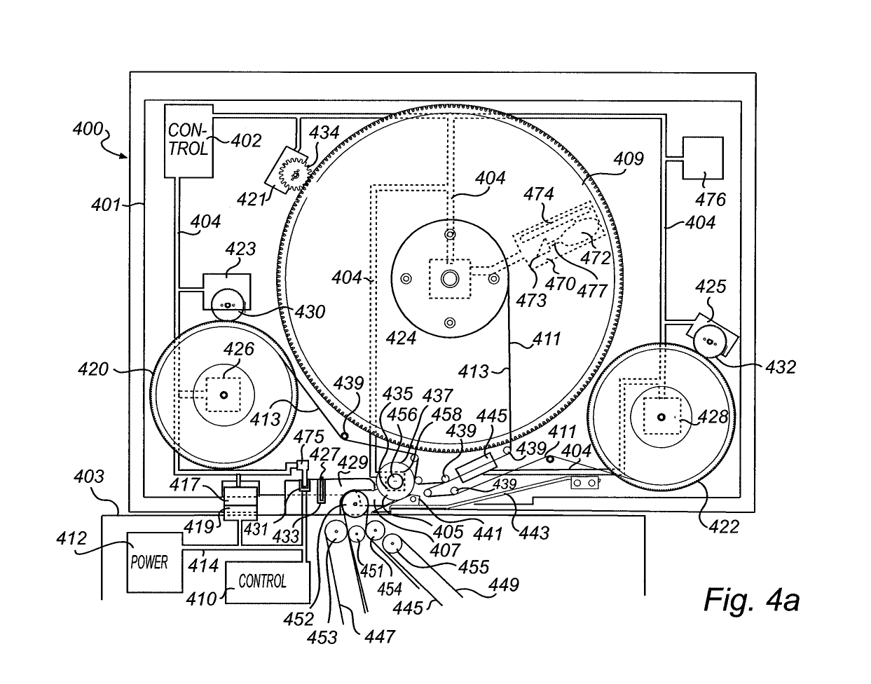

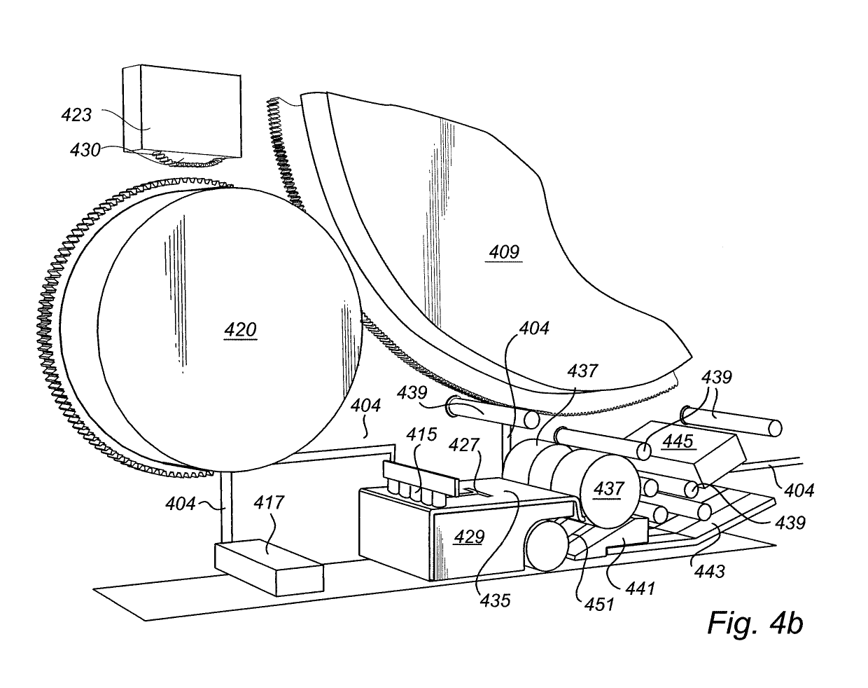

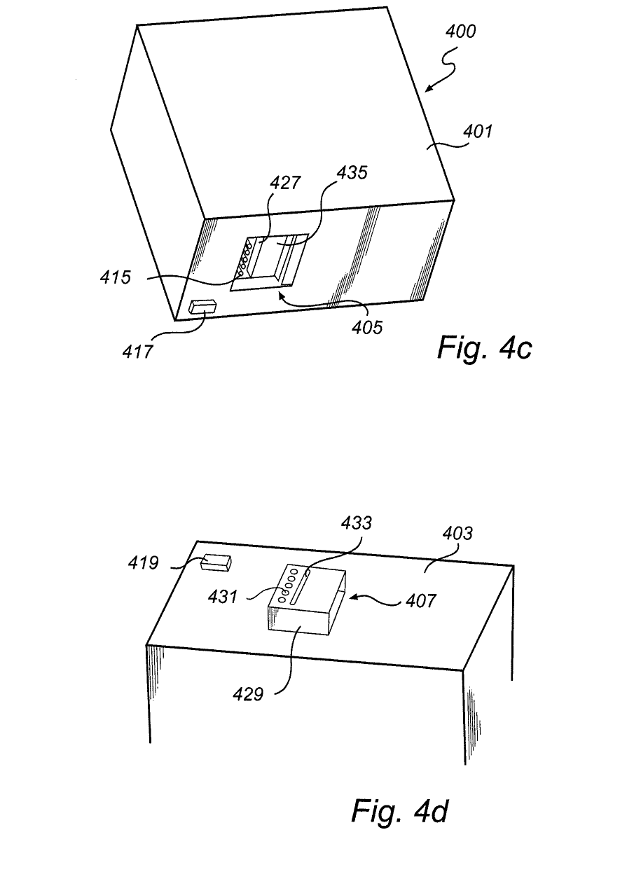

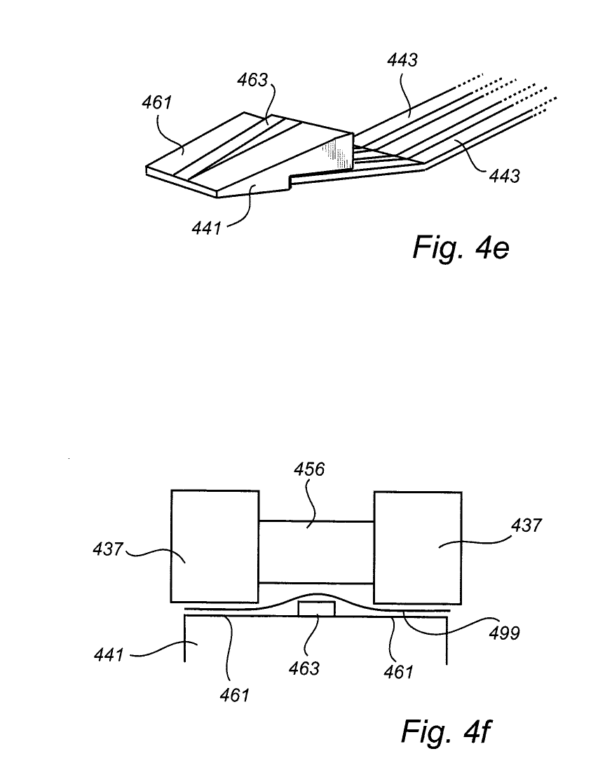

Turning now to FIGS. 4a-f, a more detailed description will be made of a transport unit 400, e.g. similar to the transport unit 200 described above, where particular emphasis will be made on the mechanical details of a cash input/output unit, a cash storage unit, mechanical engagement means and a power input connector. FIG. 4a shows a cross-sectional view of the cash transport unit 400, FIG. 4b is a view in perspective of details of the transport unit 400 attached to a cash processing unit 403 (such as a cash handling entity discussed above) and FIGS. 4c and 4d are perspective views of the transport unit 400 and the cash processing unit 403. FIG. 4e is a perspective view of an inclined ramp 441 that is arranged in the transport unit 400 for the purpose of facilitating intake of notes into the transport unit 400, and FIG. 4f is a side view of the inclined ramp 441 when in operation. It is to be noted that FIGS. 4a-f are drawn schematically and many elements of FIGS. 4a-f will be described only in functional terms, variations of which are known to the person skilled in the art.

The transport unit 400 comprises an opening 405 through which notes can be input and output. The opening 405 is configured to interface with an opening 407 in the note processing unit 403 for input and output of notes. In operation, the transport unit 400 is positioned opposite the note processing unit 403 so the note input/output openings 405, 407 are aligned, allowing notes to flow (i.e., be transferred) from the note processing unit 403 to the transport unit 400 or from the transport unit 400 to the note processing unit 403. The alignment is facilitated by a guiding flange 427 on the transport unit 400 and a corresponding guiding slit 433 on the note processing unit 403.

The transport unit 400 further comprises a note processing path comprising at least one set of co-acting belts 411 and 413. Preferably, the co-acting belts 411 and 413 are comprised of sheets of plastic film or any other suitable material. Notes are held between the belts 411 and 413 as they are moved along the note processing path. The belts 411 and 413 are spooled around respective belt storage drums 420 and 422. The belts 411 and 413 are directed to the opening 405 by a plurality of pulleys, of which a few are indicated by reference numeral 439.

Reversible motors 426 and 428 located in the belt storage drums 420 and 422 allow the belts to fed out during note intake into the transport unit 400 or retract during note outtake from the transport unit 400. Notes held between co-acting belts 411 and 413 are spooled around note storage drum 409. A reversible motor 424 located in note storage drum 409 causes the co-acting belts 411 and 413 to be wound around the drum 409 during note intake and dispensed around the drum 409 during note outtake.

As indicated in FIG. 4a, the note processing unit 403 comprises a note processing path that includes pulleys 451, 452, 453, 454, 455 and co-acting belts 445, 447, 449. Notes fed out of the transport unit 400 enter the note processing unit 403 between the co-acting belts 445, 449 aided by pulleys 451 and 454. Notes are fed out of the note processing unit 403, from between the co-acting belts 445, 447 aided by pulleys 451, 452 and 453 and further guided by a guiding structure 429. When leaving the note processing unit 403, from between pulley 452 and the structure 429, the notes are further guided in the transport unit 400 by a guide plate 435, a guide roller 437 and an inclined ramp 441. The inclined tramp 441 is resiliently suspended by a suspension arm 443.

The diameter of the guide roller 437 is smaller at a middle section, as indicated with reference numeral 456, and a suitable material for the roller 437,456 is a foam material. The guide roller 437,456 can be rotated in any direction by means of a motor 458. Clockwise rotation of the roller 437,456 feeds notes out of the transport unit 400 and anti-clockwise rotation feeds notes into the transport unit 400. This is achieved in that the guide roller 437,456 has an outer peripheral surface that interacts with the notes, which results in alteration of the direction of motion of the notes into a first or a second alternative direction. Furthermore, when in operation, the roller 437,456 interacts with the inclined ramp 441 such that the larger diameter parts of the roller 437 interact with a first upper slope surface 461, having a first slope inclination, and the middle section 456 of the roller interacts with a second upper slope surface 463, having a second slope inclination that is larger than the first slope inclination. The interaction between the roller 437,456 and the slope surfaces 461, 463 of the inclined ramp, a note being pressed between the surfaces and the roller, results in the note being slightly curved in the direction perpendicular to the direction of movement of the note. This curvature of the note provides a certain degree of stiffness to the note and thereby reduces the risk of the note folding during transfer between the transport unit 400 and the note processing unit 403. This is illustrated in FIG. 4f, where a cross sectional view, perpendicular to the direction of travel of a note 499, is shown. The note 499 is curved due to the interaction between the roller 437,4456 and the inclined ramp 441.

An electromechanical drum locking mechanism 421 comprising a locking wheel 434 is in contact with the storage drum 409. When activated, the drum locking mechanism 421 locks the wheel 434. The drum 409 is thereby prevented from rotating and intrusive actions such as forced pulling of the co-acting belts 411, 413 in order to gain access to notes stored on the drum are prevented. Preferably, the wheel 434 and the storage drum 409 are both provided with toothed edges in order to ensure a strong locking of the drum 409. The belt storage drums 420 and 422 are also arranged with such drum locking mechanisms 423 and 425, respectively, and these locking mechanisms 423, 425 each comprise a respective locking wheel 430,432.

A control unit 402 is configured with logic circuitry and memory and controls the operation of the transport unit 400, as discussed in more general terms above. More specifically, the control unit 402 is connected to the different motors 424, 426, 428, 458, the locking mechanisms 421, 423, 425 as well as a note detection unit 445, via a power and control signal bus 404.

The note detection unit 445 is arranged to detect, e.g., the type and value of notes that are carried between the belts 411 and 413. Note information that is obtained during either acceptance or distribution of notes is communicated, via the communication bus 404, to the control unit 402. Information about the source of origination of notes (e. g., a store, particular note processing unit or ATM) is preferably communicated to and processed by the processor 402 as well.

A releasable locking mechanism, comprising complementary electromechanical locking devices 417 and 419 located on the transport unit 400 and the cash processing unit 403, respectively, ensures that the two units 400, 403 can be securely locked to each other. Preferably, interlocking is achieved under the control of the control units 402, 412 located in the transport unit 400 and the cash processing unit 403, respectively.

A signalling connection between the transport unit 400 and the cash processing unit 403 is established via electric connection pins 415 in the transport unit 400 and signal sockets 431 in the cash processing unit 403. Preferably, the pins 415 are resilient in order to secure a reliable electric connection between the two units 400,403. One or more pins 415 and corresponding sockets 431 provide a power connection between the units 400,403. The transport unit is not self-sufficient in terms of electric power for operating the motors etc., but is provided with electric power from a power source 412 located in the cash processing unit 403 via the one or more electric connection pins 415.

Furthermore, one or more pins 415 and corresponding sockets 431 form a signalling connection between the units 400,403. A control unit 410 in the cash processing unit 403 communicates via a bus 414, the sockets 431 and pins 415, and via the bus 404 with the processing unit 402 in the transport unit 400.

Preferably, the alignment facilitating guiding flange 427 on the transport unit 400 and the corresponding guiding slit 433 on the note processing unit 403 also act as a ground connection between the two units 400,403. Moreover, the flange 427 is arranged such that, when the two units 400, 403 are attached to each other, the ground connection is established prior to the connection between the electric connection pins 415 and the sockets 431. This has the advantage that any electric potential difference, due to static charges, between the two units 400, 403 is eliminated and potentially damaging static electric discharge can be avoided during attachment between the units 400,403.

As indicated in FIG. 4a, the transport unit 400 is also arranged with an ink-dye protection system, although it is not configured into a secure and non-secure part as described above in connection with FIG. 2. The ink-dye protection system comprises a control circuitry 470 that is connected to a dye container 472 and sensor circuitry 476, via the bus 404. The dye container 472 with associated slits or openings 474 for expelling dye are arranged on the note storage drum 409 itself and hence rotates together with the drum 409.

The sensor circuitry 476 may be responsive to any relevant change in environmental changes such as temperature change, mechanical chock and direct intrusion into the transport unit 400, as well as being responsive to a time delay and a specific time. As a result of a detection by the sensor circuitry 476, the control circuitry 479 controls the dye container 472 to expel dye via the slit 474 in a side wall of the storage drum 409 onto any notes and film 411,413 that is spooled on the drum 409.

The ink dye protection system may also be configured such that dye is ejected through one or more dye nozzles 473 that are attached to the storage drum 409. Such a configuration may be such that the dye container 472 is not attached to the storage drum 409 itself, but is connected to the one or more nozzles 473 via an appropriately arranged dye conduit 477.

It is to be noted that the ink dye control circuitry 470 may also be comprised, wholly or in part, in the controller 402.

1. A cash transport apparatus configured to be externally connected to a note handling apparatus only during a procedure of distribution of notes between said note handling apparatus and said transport apparatus, said transport apparatus comprising:
a first opening configured to interface with a second opening in said note handling apparatus thereby enabling the distribution of notes between said note handling apparatus and said transport apparatus,
a note storage component comprising at least one drum able to rotate in both directions and configured to store notes by at least one layer of film spooled onto said at least one drum,
a power input connector configured to receive electric power from said note handling apparatus and provide the electric power to said note storage component.

2. The cash transport apparatus according to claim 1, where said interfacing prevents external access to notes being distributed between the transport unit and the cash handling apparatus.

3. The cash transport apparatus according to claim 1 or 2, configured such that said distribution of notes includes any of input of notes, output of notes, input and output of notes.

4. The cash transport apparatus according to any of claims 1 to 3, comprising a connection locking mechanism configured to lock the connection between the transport apparatus and the note handling apparatus during the procedure of distribution of notes between said note handling apparatus and said transport apparatus.

5. The cash transport apparatus according to any of claim 1 to 4, where said drum is configured with a drum locking mechanism configured to prevent and allow rotation of the drum.

6. The cash transport apparatus according to claim 5, where said drum locking mechanism is configured to detect that the transport apparatus is connected to the note handling apparatus and configured to prevent and allow rotation of the drum in response to said detection.

7. The cash transport apparatus according to any of claims 1 to 6, where the note storage component is configured such that notes can be stored on said at least one drum by being rolled between two layers of film, spooled onto said at least one drum.

8. The cash transport apparatus according to any of claims 1 to 7, comprising at least one note guiding roller arranged adjacent said first opening and configured to rotate in both directions for facilitating receiving and dispensing of notes to and from said storage component.

9. The cash transport apparatus according to claim 8, where said roller has an outer peripheral surface interacting with notes, the interaction resulting in alteration of the direction of motion of notes into any of at least a first alternative direction and a second alternative direction.

10. The cash transport apparatus according to claim 8 or 9, where said at least one note guiding roller is a foam roller.

11. The cash transport apparatus according to any of claims 1 to 10, comprising at least one note guiding means arranged adjacent said first opening and configured in the form of an inclined ramp, the inclination of which is such that it directs notes towards the roller.

12. The cash transport apparatus according to any of claims 1 to 11, further comprising a signal connector configured to convey signals between the transport apparatus and the note handling apparatus.

13. The cash transport apparatus according to claim 12, where said note storage component is responsive to control signals among said signals such that the procedure of distribution of notes between said note handling apparatus and the transport apparatus is controlled.

14. The cash transport apparatus according to any of claims 1 to 13, comprising control circuitry and where said note storage component is responsive to control signals from said control circuitry such that the procedure of distribution of notes between said note handling apparatus and the transport apparatus is controlled.

15. The cash transport apparatus according to claim 14, where the control circuitry comprises timing circuitry configured such that said note storage component is responsive to said control signals from said control circuitry in such a way that the procedure distribution of notes between said note handling apparatus and said transport apparatus is enabled only during at least one specific time interval.

16. The cash transport apparatus according to any of claims 12 to 15, comprising a user interface unit that is responsive to any of said signals such that it is capable of at least provide an indication of the progress of the procedure of distribution of notes between said note handling apparatus and the transport apparatus.

17. The cash transport apparatus according to any of claims 12 to 16, comprising encryption and decryption circuitry that is configured to encrypt and decrypt any of said signals.

18. The cash transport apparatus according to any of claims 12 to 17, comprising geographic location determination circuitry and where said note storage component is responsive to control signals from said geographic location determination circuitry such that the procedure of distribution of notes between said note handling apparatus and the transport apparatus is controlled in dependence on a determined geographic location of the transport apparatus.

19. The cash transport apparatus according to any of claims 1 to 18, comprising an ink dye protection system including:
at least one sensor for sensing any of a change of temperature, mechanical chock, intrusion, a time delay and a specific time at least one dye container, and
control circuitry configured to detect sensor output and controlling emission of dye from the dye container onto the note storage component.

20. The cash transport apparatus according to claim 19, where the dye container is attached to the note storage drum.

21. The cash transport apparatus according to claim 19, where the dye container is an integral part of the note storage drum.

22. The cash transport apparatus according to claim 19, comprising at least one dye ejector connected to the dye container, where said at least one dye ejector is attached to the note storage drum.
